(19) United States
(12) Patent Application Publication
(10) Pub. No.: US 2026/0282065 A1
(43) Pub. Date: Sep. 17, 2026

(54) INTER-CELL INTERFERENCE SUPPRESSION UNDER RIS-ASSISTED WIRELESS NETWORK

(71) Applicant: LENOVO (BEIJING) LIMITED, Beijing (CN)

(72) Inventors: Tingnan BAO, Beijing (CN); Jianfeng WANG, Beijing (CN); Haiming WANG, Beijing (CN); Lihua YANG, Beijing (CN)

(21) Appl. No.: 19/162,597

(22) PCT Filed: Mar. 10, 2023
(86) PCT No.: PCT/CN2023/080798

§ 371 Date: Sep. 5, 2025

(51) Int. Cl. H04W 72/541; H04B 7/155; H04W 72/044; H04W 72/231; H04W 84/04

(52) U.S. Cl. CPC H04W 72/541; H04B 7/15528; H04W 72/046; H04W 72/231; H04W 84/047

(57) ABSTRACT

Method and apparatus for inter-cell interference suppression under re-configurable intelligent surface (RIS)-assisted wireless network are disclosed. In one embodiment, a first network node (e.g., the base station or the UE) in a first cell comprises a transceiver; and a processor coupled to the transceiver, wherein the processor is configured to receive, via the transceiver, from a second network node in a second cell, an indication of an optimal reflection coefficient of a second RIS in the second cell, wherein the first cell is a neighboring cell of the second cell and has the same frequency as the second cell; and determine, according to the indication of the optimal reflection coefficient of the second RIS, an optimal reflection coefficient of a first RIS in the first cell for suppressing the interference of the first cell to the second cell.

### FIELD

The subject matter disclosed herein generally relates to wireless communications, and more particularly relates to methods and apparatuses for inter-cell interference suppression under re-configurable intelligent surface (RIS)-assisted wireless network.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Reconfigurable Intelligent Surface (RIS), Large Intelligent Surface (LIS), Intelligent Reflecting Surface (IRS), electromagnetic (EM), radio frequency (RF), six generation (6G), base station (BS), transmission-reception point (TRP), Signal to Interference plus Noise Ratio (SINR), received signal received power (RSRP), Channel State Information (CSI).

Reconfigurable Intelligent Surface (RIS), which can be alternatively referred to as Large Intelligent Surface (LIS), Intelligent Reflecting Surface (IRS) or Intelligent Metasurface, is an emerging technology. RIS is a large and thin metasurface of metallic or dielectric material, comprised of an array of passive sub-wavelength scattering elements with specially designed physical structure. The elements can be controlled in a software-defined manner to change the electromagnetic (EM) properties (e.g., phase shift and/or amplitude attenuation) of the reflection of the incident radio frequency (RF) signals. By a joint phase control of all scattering elements, the reflected radiation pattern of the incident RF signals can be arbitrarily tuned in real time, thus creating new degrees of freedom to the optimization of the overall wireless network performance. RIS can real-time control the response of electromagnetic wave effectively and is considered as one of the potential key technologies for 6G systems.

A typical deployment of RIS in a modern mobile communication system is illustrated in FIG. 1, where the RIS is controlled by a base station (BS), e.g., gNB or TRP, via a dedicated interface (note that the interface may be defined if the RIS is regarded as a new node category in 6G networks). The RIS forwards the signal from the BS to the target user equipment (UE). That is, the RIS forms a cascaded link between the BS and the UE in addition to a direct link from the BS to the UE.

This invention targets inter-cell interference suppression scheme under RIS-assisted wireless network.

### BRIEF SUMMARY

Method and apparatus for inter-cell interference suppression under re-configurable intelligent surface (RIS)-assisted wireless network are disclosed.

In one embodiment, a first network node (e.g., the base station or the UE) in a first cell comprises a transceiver; and a processor coupled to the transceiver, wherein the processor is configured to receive, via the transceiver, from a second network node in a second cell, an indication of an optimal reflection coefficient of a second RIS in the second cell, wherein the first cell is a neighboring cell of the second cell and has the same frequency as the second cell; and determine, according to the indication of the optimal reflection coefficient of the second RIS, an optimal reflection coefficient of a first RIS in the first cell for suppressing the interference of the first cell to the second cell.

In some embodiment, the optimal reflection coefficient of the first RIS results in a reflection direction by the first RIS being orthogonal to the reflection direction by the second RIS resulted by the optimal reflection coefficient of the second RIS.

In some embodiment, the processor is further configured to receive, via the transceiver, a matching map of the first RIS and the second RIS; and the processor is configured to determine the optimal reflection coefficient of the first RIS according to the indication of the optimal reflection coefficient of the second RIS, which is an index of the optimal reflection coefficient of the second RIS, and the matching map. In particular, the matching map includes multiple pairs, each of which includes a reflection coefficient of the first RIS and a reflection coefficient of the second RIS, and the optimal reflection coefficient of the first RIS is determined from any pair including the optimal reflection coefficient of the second RIS other than the pair that includes the optimal reflection coefficient of the second RIS and the reflection coefficient of the first RIS that results the best signal transmission via the first RIS.

In some embodiment, the first network node is a first base unit in the first cell, and the second network node is a second base unit in the second cell. The optimal reflection coefficient of the second RIS is determined according SINRs or RSRPs reported to the second network node by a UE in the second cell, wherein the SINRs or RSRPs are calculated for each candidate reflection coefficient of the second RIS. The processor may be configured to receive, via the transceiver, from the second base unit, the indication of the optimal reflection coefficient of the second RIS over Xn interface.

In some embodiment, the first network node is a first UE in the first cell, and the second network node is a second UE in the second cell. The optimal reflection coefficient of the second RIS may be determined by the second UE according SINRs or RSRPs calculated for each candidate reflection coefficient of the second RIS. The processor may be configured to receive, via the transceiver, from the second UE, the indication of the optimal reflection coefficient of the second RIS over PC5 interface. Alternatively, the processor is configured to receive, via the transceiver, from a base unit in the first cell, the indication of the optimal reflection coefficient of the second RIS by RRC signaling or MAC CE.

In another embodiment, a method performed at a base station or a UE comprises: receiving, from a second network node in a second cell, an indication of an optimal reflection coefficient of a second RIS in the second cell, wherein the first cell is a neighboring cell of the second cell and has the same frequency as the second cell; and determining, according to the indication of the optimal reflection coefficient of the second RIS, an optimal reflection coefficient of a first RIS in the first cell for suppressing the interference of the first cell to the second cell.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a typical deployment of RIS in a modern mobile communication system;

FIG. 2 illustrates a RIS-assisted downlink multi-cell wireless system;

FIG. 3 illustrates a procedure according to a first embodiment;

FIG. 4 illustrates a procedure according to a second embodiment;

FIG. 5 illustrates a procedure according to a third embodiment;

FIG. 6 illustrates a procedure according to a fourth embodiment;

FIG. 7 is a schematic flow chart diagram illustrating an embodiment of a method; and

FIG. 8 is a schematic block diagram illustrating apparatuses according to one embodiment.

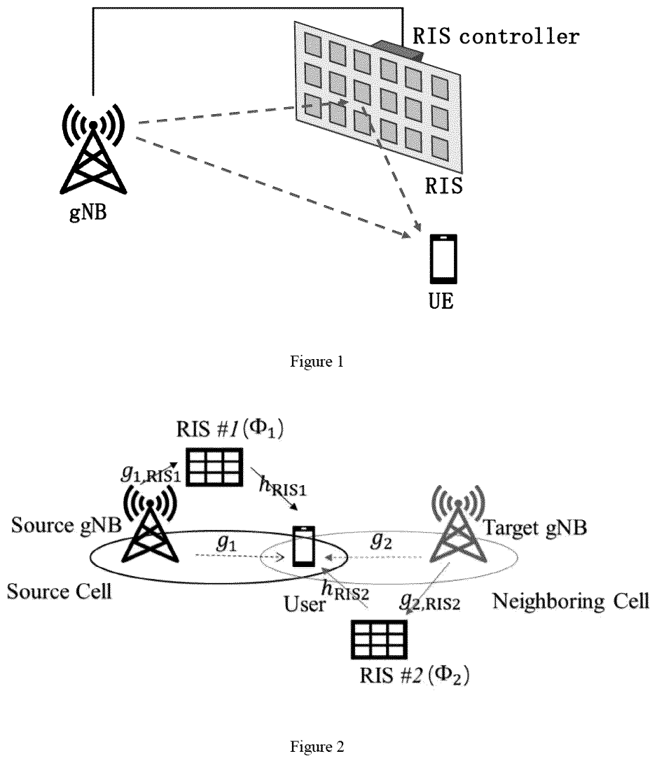

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

In a cellular network, multiple cells may operate in the same frequency to improve the spectrum utilization. Each cell may have a gNB placed at the center of the cell that serves a set of UEs. The cells operating on the same carrier frequency are called co-channel cells. A UE in one of co-channel cells, especially a UE located at cell-edge, may suffer interference from another co-channel cell (or from multiple co-channel cells), which can be referred to as inter-cell interference. It is necessary to eliminate or at least suppress inter-cell interference for enhancing the system performance.

This disclosure relates to suppressing inter-cell interference for RIS-assisted wireless network.

A RIS-assisted downlink multi-cell wireless system is shown in FIG. 2. A cell-edge user (or cell-edge UE) is located between a source cell and a neighboring cell. It means that the user can be served by both the source cell and the neighboring cell. Each cell has a gNB and a RIS. In particular, the source cell includes a source gNB and RIS #1; and the neighboring cell includes a target gNB and RIS #2.

The cell-edge user can receive the signal from four links: a direct link directly from the source gNB, a cascaded link from the source gNB via RIS #1, a direct link directly from the target gNB, and a cascaded link from the target gNB via RIS #2. Incidentally, the cascaded link from the source gNB via RIS #2 and the cascaded link from the target gNB via RIS #1 are ignored since the path loss effect between gNB and RIS in different cells is relatively weak.

Without loss of generality, it is assumed that all RISs (e.g., RIS #1 and RIS #2) have the same number of reflection elements (e.g., M reflection elements, where M>=1).

The channel gain from the source gNB directly to the cell-edge user is denoted as g₁; the channel gain from the source gNB to RIS #1 is denoted as g_{1,RIS1}; and the channel gain from RIS #1 to the cell-edge user is denoted as h_{RIS1}. Similarly, the channel gain from the target gNB directly to the cell-edge user is denoted as g₂; the channel gain from the target gNB to RIS #2 is denoted as g_{2,RIS2}; and the channel gain from RIS #2 to the cell-edge user is denoted as h_{RIS2}.

There can be one source cell and multiple neighboring cells (e.g., one source cell and L−1 neighboring cells). The diagonal reflection matrix of the RIS (where, it is assumed that each cell has one RIS) in the l^{th} (l is from 1 to L) cell is denoted by Φ₁=diag(Øₗ₁, Øₗ₂, . . . , Ø_{lM}), where Øₗₘ=aₗₘe^{jθ}^{ₗₘ} is the m^{th} (m is from 1 to M) reflection coefficient of the RIS in the l^{th} cell, where aₗₘ is the amplitude of the m^{th} element, and θₗₘ is the phase of the m^{th} element.

To make simplification, in the following description, it is assumed that there is only one neighboring cell. It means that the first cell is the source cell, and the second cell is the neighboring cell. So, the diagonal reflection matrix of the RIS of the source cell (e.g., RIS #1 in FIG. 2) is denoted by Φ₁; and the diagonal reflection matrix of the RIS of the neighboring cell (e.g., RIS #2 in FIG. 2) is denoted by Φ₂.

The transmitted symbol at gNB in the first cell (i.e., source cell) is represented by x₁; and the transmitted symbol at gNB in the second cell (i.e., neighboring cell) is represented by x₂. Accordingly, the overall received signal including interference and noise at the cell-edge user is given by y=(g₁+g_{1,RIS1}Φ₁h_{RIS1})x₁+(g₂+g_{2,RIS2}Φ₂h_{RIS2})x₂+z, where (g₁+g_{1,RIS1}Φ₁h_{RIS1})x₁ is the desired signal, (g₂+g_{2,RIS2}Φ₂h_{RIS2})x₂ is the inter-cell interference signal, and z is the additive white Gaussian noise within z~CN(0, σ²) (it means that z follows the Gaussian distribution (or Normal distribution) where the mathematic expectation (or average value) is 0 and the variance is σ²).

Accordingly, the Signal to Interference plus Noise Ratio (SINR) of the cell-edge user in the source cell can be modeled as Equation #1:

$$SINR = \frac{{\vert {g}_{1} + {g}_{1 , {RIS}_{1}} {Φ}_{1} {h}_{{RIS}_{1}} \vert}^{2} P}{{\vert {g}_{2} + {g}_{2 , {RIS}_{2}} {Φ}_{2} {h}_{{RIS}_{2}} \vert}^{2} P + {σ}^{2}} ,$$

where P denotes the transmission power per resource block in each cell.

It can be seen from Equation #1 that the system performance can be improved by decreasing the inter-cell interference |g₂+g_{2,RIS2} Φ₂h_{RIS2}|. In particular, the diagonal reflection matrix of RIS #2 (i.e., Φ₂) can be configured to change the reflection direction of the signal reflected by RIS #2, resulting in the change of the channel gain h_{RIS2}. As such, both Φ₂ and h_{RIS2} can be changed to suppress the inter-cell interference.

Φ₂=diag(Ø₂₁, Ø₂₂, . . . , Ø_{2M}), where Ø₂ₘ=a₂ₘe^{jθ}^{₂ₘ}, m=1 to M, a₂ₘ is the amplitude of the m^{th} element, and θ₂ₘ is the phase of the m^{th} element.

A combination of Ø₂₁, Ø₂₂, . . . , Ø_{2M} can be referred to as a reflection coefficient of RIS #2. Each of Ø₂₁, Ø₂₂, . . . , Ø_{2M} is dependent on a₂ₘ (i.e., amplitude) and θ₂ₘ (i.e., phase). To make simplification, it is assumed that the amplitude of each element is fixed as 1, for example for far-filed communication. It means that each of Ø₂₁, Ø₂₂, . . . , Ø_{2M} can be regarded as being dependent on θ₂ₘ (i.e., phase) of each element. So, each combination of θ₂ₘ where m is from 1 to M (i.e., each combination of θ₂₁, θ₂₂, . . . , θ_{2M}) corresponds to a reflection direction of the signal reflected by RIS #2. So, if it is assumed that the amplitude of each element is fixed as 1, a combination of θ₂₁, θ₂₂ . . . , θ_{2M} can also be referred to as a reflection coefficient of RIS #2. Each reflection coefficient of RIS #2 can result in a different reflection direction of RIS #2.

The RIS can be controlled either by the gNB of the cell where the RIS is employed, or by the UE in the cell. In a first scenario, each gNB in a cell can control and configure the phase of each element of the RIS (or the reflection coefficient of the RIS) in the cell. In a second scenario, any UE in a cell can control and configure the phase of each element of the RIS (or the reflection coefficient of the RIS) in the cell.

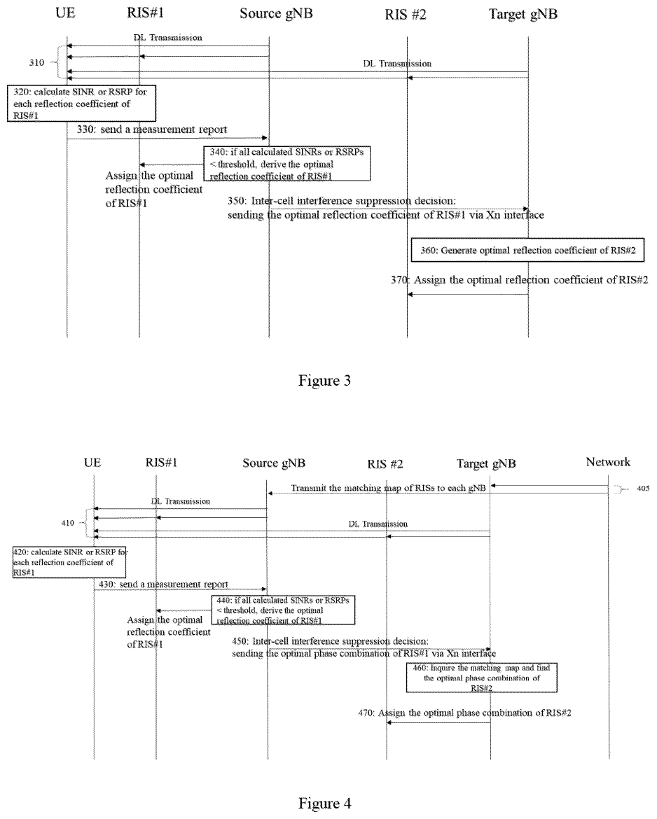

A first embodiment relates to a first solution in the first scenario. FIG. 3 illustrates the procedure of the first embodiment.

The UE can be the cell-edge user illustrated in FIG. 2, which is at the cell-edge area between the source gNB and the target gNB. The source gNB controls RIS #1; and the target gNB controls RIS #2.

In step 310, UE, that is in RRC_CONNECTED state, receives the downlink data. In particular, the UE can receive useful signals on both a first direct link from the source gNB and a first cascaded link from the source gNB via RIS #1. In addition, the UE can also receive interference signals on both a second direct link from the target gNB and a second cascaded link from the target gNB via RIS #2.

RIS #1 can be controlled in the same way as RIS #2. That is, the diagonal reflection matrix of RIS #1 (i.e., Φ₁) can be configured to change the reflection direction of the signal reflected by RIS #1. Φ₁=diag(Ø₁₁, Ø₁₂, . . . , Ø_{1M}), where Ø₁ₘ=a₁ₘe^{jθ}^{₁ₘ}, m=1 to M, a₁ₘ is the amplitude of the m^{th} element, and θ₁ₘ is the phase of the m^{th} element. A combination of Ø₁₁, Ø₁₂, . . . , Ø_{1M} can be referred to as a reflection coefficient of RIS #1. Similarly, it is assumed that the amplitude of each element is fixed at one. So, a combination of θ₁₁, θ₁₂, . . . , θ_{1M} can also be referred to as a reflection coefficient of RIS #1. Each reflection coefficient of RIS #1 can result in a different reflection direction by RIS #1.

To make clarification, it is assumed that RIS #1 has N₁ (N₁>=1) candidate reflection coefficients; and RIS #2 has N₂ (N₂>=1) candidate reflection coefficients.

In step 320, in the condition that RIS #2 is configured with any one of N₂ reflection coefficients, the UE calculates SINR (e.g., L1-SINR) or RSRP (e.g., L1-RSRP) based on the received useful signals and the received interference signals, for each of N₁ reflection coefficients of RIS #1 that can be configured.

In step 330, the UE can send a measurement report (e.g., CSI report) to the source gNB, where the measurement report includes the calculated SINR or RSRP for each of N₁ reflection coefficients of RIS #1.

In step 340, upon receiving the measurement report, if all of the calculated SINRs or RSRPs (for all N₁ reflection coefficients of RIS #1) are lower than a predefined threshold, the source gNB may determine a poor signal quality and that the poor signal quality is caused by strong interference (e.g., inter-cell interference). Accordingly, the source gNB can determine an optimal reflection coefficient of RIS #1 with

$${N}_{opt} = \begin{matrix}argmax \\ {N}_{1}\end{matrix} RSRP or {N}_{opt} = \begin{matrix}argmax \\ {N}_{1}\end{matrix} SINR .$$

That is, among the signal qualities caused by N reflection coefficients of RIS #1, the reflection coefficient that causes the best signal quality is determined as the optimal reflection coefficient of RIS #1. The source gNB assigns this optimal reflection coefficient to RIS #1 to increase the received signal.

In step 350, the source gNB decides to suppress the inter-cell interference. In particular, the source gNB can trigger inter-cell interference suppression message to one or more neighboring gNBs (e.g., the target gNB) via Xn interface by sending the optimal reflection coefficient of RIS #1 to the target gNB.

In step 360, upon receiving the inter-cell interference suppression message including the optimal reflection coefficient of RIS #1, the target gNB determines, based on the optimal reflection coefficient of RIS #1, an optimal reflection coefficient of RIS #2 that can maximally suppress the transmission via RIS #2 (that means the interference on the second cascaded link from target gNB via RIS #2 can be minimized). For example, the reflection coefficient of RIS #2 that results in a reflection direction by RIS #2 that is orthogonal to the reflection direction by RIS #1 resulted by the optimal reflection coefficient of RIS #1 can be determined as the optimal reflection coefficient of RIS #2 to decrease the inter-cell interference.

In step 370, the target gNB assigns the optimal reflection coefficient of RIS #2 to RIS #2.

The optimal reflection coefficient (e.g., optimal combination of phases of the elements) of RIS #2 can make the inter-cell interference |g₂+g_{2,RIS2}Φ₂h_{RIS2}| smaller, so that the inter-cell interference in the RIS-aided link from the neighboring cell can be suppressed.

A second embodiment relates to a second solution in the first scenario. FIG. 4 illustrates the procedure of the second embodiment.

According to the second embodiment, a directional relationship between RIS #1 and RIS #2 to suppress the inter-cell interference is considered for decreasing the system processing time. In consideration that different reflection coefficients of RIS can lead to different reflection directions by the RIS, a matching map between RIS #1 and RIS #2 can be established. To make explanation simpler, it is assumed that RIS #1 has three (3) discrete reflection coefficients that result in three reflection directions

$$( e . g . , \{ 1 , {e}^{j \frac{2 π}{3}} , {e}^{j \frac{4 π}{3}} \} )$$

and RIS #2 has two (2) discrete reflection coefficients that result in two reflection directions (e.g., {1, e^{jπ}}), as shown in Table 1, where Pair (m, n) means the signal effect between the reflecting direction of RIS #1 with the m^{th} reflection coefficient and the reflecting direction of RIS #2 with the n^{th} reflection coefficient.

TABLE 1

| Pair | RIS#1_Index 1 | RIS#1_Index 2 | RIS#1_Index 3 |
|---|---|---|---|
| RIS#2_Index 1 | Pair (1, 1) | Pair (2, 1) | Pair (3, 1) |
| RIS#2_Index 2 | Pair (1, 2) | Pair (2, 2) | Pair (3, 2) |

An example of the pairs and their values are shown in Table 2.

TABLE 2

| Pair | Value |
|---|---|
| (1, 1) | [1, 1] |
| (2, 1) | $[ {e}^{j \frac{2 π}{3}} , 1 ]$ |
| (3, 1) | $[ {e}^{j \frac{4 π}{3}} , 1 ]$ |
| (1, 2) | [1, e^{jπ}] |
| (2, 2) | $[ {e}^{j \frac{2 π}{3}} , {e}^{j π} ]$ |
| (3, 2) | $[ {e}^{j \frac{4 π}{3}} , {e}^{j π} ]$ |

In step 405, both the source gNB and the target gNB receive the matching map between their RISs (e.g., between RIS #1 and RIS #2).

Steps 410, 420, 430, 440 and 450 are substantially the same as steps 310, 320, 330, 340 and 350, respectively. Some differences are described as follows: In step 440, the optimal reflection coefficient is an index of one of the candidate reflection coefficients. For example, index 3 of RIS #1 can be determined. In step 450, the sent optimal reflection coefficient of RIS #1 is index 3 of RIS #1.

In step 460, upon receiving the inter-cell interference suppression message including the optimal reflection coefficient of RIS #1 (i.e., the index of the optimal reflection coefficient of RIS #1), the target gNB inquires the matching map including pair information, to find which reflection direction of RIS #2 achieves the best signal transmission to the UE. For example, when the sent optimal reflection coefficient of RIS #1 is index 3, Pair (3,1) is the pair information where the third reflection coefficient of RIS #1 is the received optimal reflection coefficient of RIS #1 from the source gNB; and the first reflection coefficient of RIS #2 can achieve the best signal transmission to the UE via RIS #2. It means that Pair (3,1) is not favorite if the signal transmission to the UE via RIS #2 serves as interference. That is, Pair (3, x), where x is not 1, can be selected. In other words, reflection coefficient x (where x is not 1) of RIS #2 can be selected as the optimal reflection coefficient of RIS #2 to suppress inter-cell interference. In the example of Table 2, there is only pair (3, 2) except for pair (3, 1). So, the second reflection coefficient (i.e., the index of the reflection coefficient is 2) of RIS #2 is selected as the optimal reflection coefficient of RIS #2 to suppress inter-cell interference. Incidentally, if there are multiple pairs except for the pair (3, 1), one of the multiple pairs can be randomly selected. That is, the reflection coefficient of RIS #2 in any of the pairs (3, x) where x is not 1 can be selected.

Step 470 is the same as step 370.

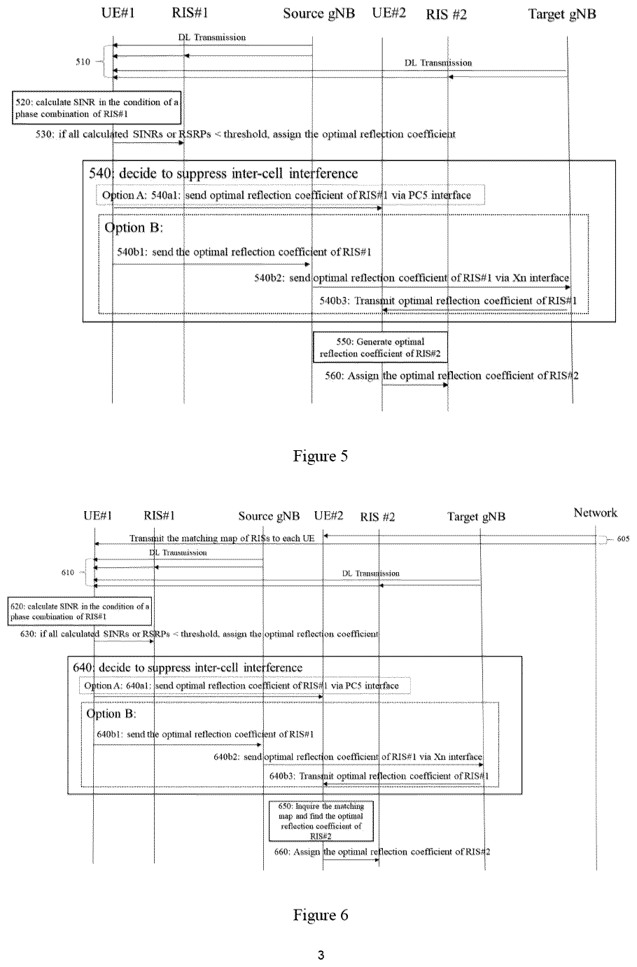

A third embodiment relates to a first solution in the second scenario. FIG. 5 illustrates the procedure of the third embodiment.

UE #1 is a cell-edge user, which can be illustrated in FIG. 2 at the cell-edge area between the source gNB and the target gNB. UE #1 controls RIS #1. UE #2 (not shown in FIG. 2) is a user that is within the coverage of the neighboring cell. UE #2 controls RIS #2.

In step 510, UE #1, that is in RRC_CONNECTED state, receives the downlink data. In particular, UE #1 can receive useful signals on both a first direct link from the source gNB and a first cascaded link from the source gNB via RIS #1. In addition, UE #1 can receive interference signals on both a second direct link from the target gNB and a second cascaded link from the target gNB via RIS #2. It is assumed that RIS #1 has N₁ (N₁>=1) reflection coefficients; and RIS #2 has N₂ (N₂>=1) reflection coefficients.

In step 520, in the condition that RIS #2 is configured with any one of N₂ reflection coefficients, UE #1 calculates SINR (e.g., L1-SINR) or RSRP (e.g., L1-RSRP) based on the received useful signals and the received interference signals, for each of N₁ reflection coefficients of RIS #1 that can be configured.

In step 530, if all the calculated SINRs or RSRPs (for all My reflection coefficients of RIS #1) are lower than a predefined threshold, UE #1 determines a poor signal quality and that the poor signal quality is caused by strong interference (e.g., inter-cell interference). Accordingly, UE #1 can determine an optimal reflection coefficient of RIS #1 with

$${N}_{opt} = \begin{matrix}argmax \\ {N}_{1}\end{matrix} RSRP or {N}_{opt} = \begin{matrix}argmax \\ {N}_{1}\end{matrix} SINR .$$

UE #1 assigns the optimal reflection coefficient of RIS #1 to RIS #1.

In step 540, UE #1 decides to suppress the inter-cell interference (e.g., by triggering inter-cell interference suppression event).

Two options (e.g., Option A and Option B) are proposed to implement step 540.

In Option A, it is assumed that sidelink protocol can be enabled between UE #1 and UE #2, where UE #2 in the neighboring cell can control RIS #2. In step 540a1, UE #1 sends inter-cell interference suppression message to UE #2 via PC5 interface by sending the optimal reflection coefficient of RIS #1.

In Option B, it is assumed that sidelink protocol cannot be enabled between UE #1 and UE #2. In step 540b1, UE #1 sends the optimal reflection coefficient of RIS #1 to the source gNB. For example, the optimal reflection coefficient RIS #1 can be included in a CSI report to be sent to the source gNB. In step 540b2, the source gNB sends an inter-cell interference suppression message to one or more neighboring gNBs (e.g., target gNB) via Xn interface by sending the optimal reflection coefficient of RIS #1. In step 540b3, the target gNB transmits the optimal reflection coefficient of RIS #1 to UE #2, e.g., by higher layer signaling such as RRC signaling or by MAC CE.

In step 550, UE #2 can generate an optimal reflection coefficient of RIS #2 in the same manner as described in step 360.

In step 560, UE #2 assigns the optimal reflection coefficient of RIS #2 to RIS #2.

A fourth embodiment relates to a second solution in the second scenario. FIG. 6 illustrates the procedure of the second embodiment.

The fourth embodiment is similar to the second embodiment, that is, a directional relationship between RIS #1 and RIS #2 to suppress the inter-cell interference is considered for decreasing the system processing time.

In step 605, the matching map between RISs (e.g., between RIS #1 and RIS #2) is received by both UE #1 that can control RIS #1 and UE #2 that can control RIS #2. For example, the matching map between RIS #1 and RIS #2 can be broadcasted in the source cell (including RIS #1) and the neighboring cell (including RIS #2).

Steps 610, 620, 630 and 640 are substantially the same as steps 510, 520, 530 and 540, respectively. Some differences are described as follows: In step 640, the optimal reflection coefficient is an index to one of the candidate reflection coefficients. For example, index 3 of RIS #1 can be determined.

In step 650, the optimal reflection coefficient of RIS #2 is generated in the same manner as described in step 460.

Step 660 is the same as step 560.

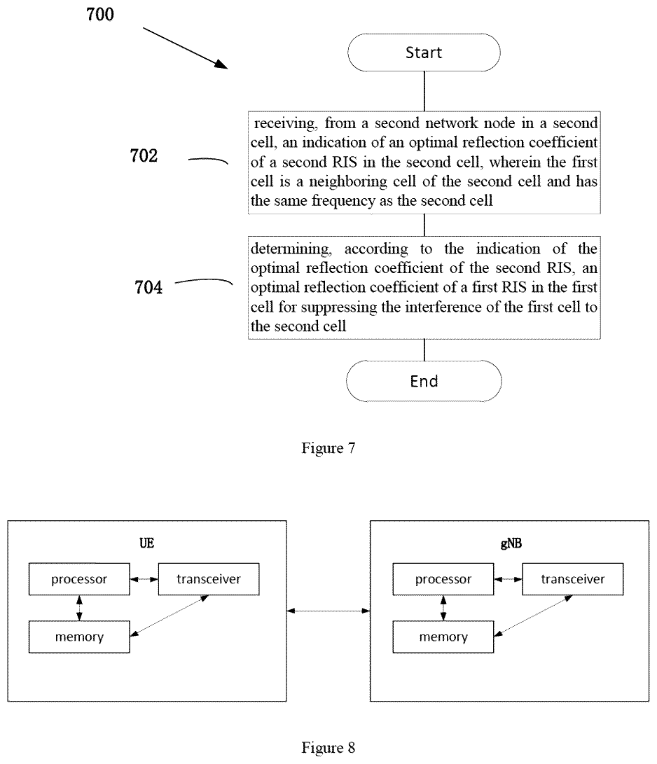

FIG. 7 is a schematic flow chart diagram illustrating an embodiment of a method 700 according to the present application. In some embodiments, the method 700 is performed by a first network node, such as a base station or a UE of a serving cell. In certain embodiments, the method 700 may be performed by a processor executing program code, for example, a microcontroller, a microprocessor, a CPU, a GPU, an auxiliary processing unit, a FPGA, or the like.

The method 700 may comprise 702 receiving, from a second network node in a second cell, an indication of an optimal reflection coefficient of a second RIS in the second cell, wherein the first cell is a neighboring cell of the second cell and has the same frequency as the second cell; and 704 determining, according to the indication of the optimal reflection coefficient of the second RIS, an optimal reflection coefficient of a first RIS in the first cell for suppressing the interference of the first cell to the second cell.

In some embodiment, the optimal reflection coefficient of the first RIS results in a reflection direction by the first RIS being orthogonal to the reflection direction by the second RIS resulted by the optimal reflection coefficient of the second RIS.

In some embodiment, the method further comprises receiving a matching map of the first RIS and the second RIS; and the optimal reflection coefficient of the first RIS is determined according to the indication of the optimal reflection coefficient of the second RIS, which is an index of the optimal reflection coefficient of the second RIS, and the matching map. In particular, the matching map includes multiple pairs, each of which includes a reflection coefficient of the first RIS and a reflection coefficient of the second RIS, and the optimal reflection coefficient of the first RIS is determined from any pair including the optimal reflection coefficient of the second RIS other than the pair that includes the optimal reflection coefficient of the second RIS and the reflection coefficient of the first RIS that results the best signal transmission via the first RIS.

In some embodiment, the first network node is a first base unit in the first cell, and the second network node is a second base unit in the second cell. The optimal reflection coefficient of the second RIS may be determined according SINRs or RSRPs reported to the second network node by a UE in the second cell, wherein the SINRs or RSRPs are calculated for each candidate reflection coefficient of the second RIS. The method may further comprise receiving, from the second base unit, the indication of the optimal reflection coefficient of the second RIS over Xn interface.

In some embodiment, the first network node is a first UE in the first cell, and the second network node is a second UE in the second cell. The optimal reflection coefficient of the second RIS may be determined by the second UE according SINRs or RSRPs calculated for each candidate reflection coefficient of the second RIS. The method may further comprise receiving, from the second UE, the indication of the optimal reflection coefficient of the second RIS over PC5 interface. Alternatively, the method may further comprise receiving, from a base unit in the first cell, the indication of the optimal reflection coefficient of the second RIS by RRC signaling or MAC CE.

FIG. 8 is a schematic block diagram illustrating apparatuses according to one embodiment.

Referring to FIG. 8, the UE (i.e. the remote unit) includes a processor, a memory, and a transceiver that is a transmitter and/or a receiver. The base station (e.g., gNB) includes a processor, a memory, and a transceiver that is a transmitter and/or a receiver. The processor (e.g, the processor of the UE, or the processor of the gNB) implements a function, a process, and/or a method which are proposed in FIG. 7.

A first network node (e.g., the base station or the UE) in a first cell comprises a transceiver; and a processor coupled to the transceiver, wherein the processor is configured to receive, via the transceiver, from a second network node in a second cell, an indication of an optimal reflection coefficient of a second RIS in the second cell, wherein the first cell is a neighboring cell of the second cell and has the same frequency as the second cell; and determine, according to the indication of the optimal reflection coefficient of the second RIS, an optimal reflection coefficient of a first RIS in the first cell for suppressing the interference of the first cell to the second cell.

In some embodiment, the optimal reflection coefficient of the first RIS results in a reflection direction by the first RIS being orthogonal to the reflection direction by the second RIS resulted by the optimal reflection coefficient of the second RIS.

In some embodiment, the processor is further configured to receive, via the transceiver, a matching map of the first RIS and the second RIS; and the processor is configured to determine the optimal reflection coefficient of the first RIS according to the indication of the optimal reflection coefficient of the second RIS, which is an index of the optimal reflection coefficient of the second RIS, and the matching map. In particular, the matching map includes multiple pairs, each of which includes a reflection coefficient of the first RIS and a reflection coefficient of the second RIS, and the optimal reflection coefficient of the first RIS is determined from any pair including the optimal reflection coefficient of the second RIS other than the pair that includes the optimal reflection coefficient of the second RIS and the reflection coefficient of the first RIS that results the best signal transmission via the first RIS.

In some embodiment, the first network node is a first base unit in the first cell, and the second network node is a second base unit in the second cell. The optimal reflection coefficient of the second RIS is determined according SINRs or RSRPs reported to the second network node by a UE in the second cell, wherein the SINRs or RSRPs are calculated for each candidate reflection coefficient of the second RIS. The processor may be configured to receive, via the transceiver, from the second base unit, the indication of the optimal reflection coefficient of the second RIS over Xn interface.

In some embodiment, the first network node is a first UE in the first cell, and the second network node is a second UE in the second cell. The optimal reflection coefficient of the second RIS may be determined by the second UE according SINRs or RSRPs calculated for each candidate reflection coefficient of the second RIS. The processor may be configured to receive, via the transceiver, from the second UE, the indication of the optimal reflection coefficient of the second RIS over PC5 interface. Alternatively, the processor is configured to receive, via the transceiver, from a base unit in the first cell, the indication of the optimal reflection coefficient of the second RIS by RRC signaling or MAC CE.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A first network node in a first cell, comprising:
at least one memory; and
at least one processor coupled with the at least one memory and configure to cause the first network node to:
receive, from a second network node in a second cell, an indication of an optimal reflection coefficient of a second reconfigurable intelligent surface (RIS) in the second cell, wherein the first cell is a neighboring cell of the second cell and has the same frequency as the second cell; and
determine, according to the indication of the optimal reflection coefficient of the second RIS, an optimal reflection coefficient of a first RIS in the first cell for suppressing interference of the first cell to the second cell.

2. The first network node of claim 1, wherein the optimal reflection coefficient of the first RIS results in a reflection direction by the first RIS being orthogonal to a reflection direction by the second RIS based on the optimal reflection coefficient of the second RIS.

3. The first network node of claim 1, wherein
the at least one processor is further configured to cause the first network node to; receive a matching map of the first RIS and the second RIS; and
determine the optimal reflection coefficient of the first RIS according to the indication of the optimal reflection coefficient of the second RIS,
which is an index of the optimal reflection coefficient of the second RIS, and the matching map.

4. The first network node of claim 3, wherein the matching map includes multiple pairs, each of which includes a reflection coefficient of the first RIS and a reflection coefficient of the second RIS, and
the optimal reflection coefficient of the first RIS is determined from any pair including the optimal reflection coefficient of the second RIS other than a pair that includes the optimal reflection coefficient of the second RIS and the reflection coefficient of the first RIS resulting in a best signal transmission via the first RIS.

5. The first network node of claim 1, wherein the first network node is a first base unit in the first cell, and wherein the second network node is a second base unit in the second cell.

6. The first network node of claim 5, wherein the optimal reflection coefficient of the second RIS is determined based on signal to interference noise ratios (SINRs) or reference signal received powers (RSRPs) reported to the second network node by a user equipment (UE) in the second cell, wherein the SINRs or RSRPs are calculated for each candidate reflection coefficient of the second RIS.

7. The first network node of claim 5, wherein the at least one processor is configured to cause the first network node to receive, from the second base unit, the indication of the optimal reflection coefficient of the second RIS over an Xn interface.

8. The first network node of claim 1, wherein the first network node is a first user equipment (UE) in the first cell, and the second network node is a second UE in the second cell.

9. The first network node of claim 8, wherein the optimal reflection coefficient of the second RIS is determined by the second UE according to signal to interference noise ratios (SINRs) or reference signal received powers (RSRPs) calculated for each candidate reflection coefficient of the second RIS.

10. The first network node of claim 8, wherein the at least one processor is configured to cause the first network node to receive, from the second UE, the indication of the optimal reflection coefficient of the second RIS over a PC5 interface.

11. The first network node of claim 8, wherein the at least one processor is configured to cause the first network node to receive, from a base unit in the first cell, the indication of the optimal reflection coefficient of the second RIS by radio resource control (RRC) signaling or via a media access control (MAC) control element (CE).

12. A method performed at a first network node in a first cell, the method comprising:
receiving, from a second network node in a second cell, an indication of an optimal reflection coefficient of a second reconfigurable intelligent surface (RIS) in the second cell, wherein the first cell is a neighboring cell of the second cell and has the same frequency as the second cell; and
determining, according to the indication of the optimal reflection coefficient of the second RIS, an optimal reflection coefficient of a first RIS in the first cell for suppressing the interference of the first cell to the second cell.

13. The method of claim 12, wherein the optimal reflection coefficient of the first RIS results in a reflection direction by the first RIS being orthogonal to a reflection direction by the second RIS based on the optimal reflection coefficient of the second RIS.

14. The method of claim 12, further comprising:
receiving a matching map of the first RIS and the second RIS; and
determining the optimal reflection coefficient of the first RIS according to the indication of the optimal reflection coefficient of the second RIS, which is an index of the optimal reflection coefficient of the second RIS, and the matching map.

15. The method of claim 14, wherein the matching map includes multiple pairs, each of which includes a reflection coefficient of the first RIS and a reflection coefficient of the second RIS, and
the optimal reflection coefficient of the first RIS is determined from any pair including the optimal reflection coefficient of the second RIS other than a pair that includes the optimal reflection coefficient of the second RIS and the reflection coefficient of the first RIS resulting in a best signal transmission via the first RIS.

16. The method of claim 12, wherein the first network node is a first base unit in the first cell, and wherein the second network node is a second base unit in the second cell.

17. The method of claim 16, wherein the optimal reflection coefficient of the second RIS is determined based on signal to interference noise ratios (SINRs) or reference signal received powers (RSRPs) reported to the second network node by a user equipment (UE) in the second cell, wherein the SINRs or RSRPs are calculated for each candidate reflection coefficient of the second RIS.

18. The method of claim 16, wherein the indication of the optimal reflection coefficient of the second RIS is received over an Xn interface.

19. The method of claim 12, wherein the first network node is a first user equipment (UE) in the first cell, and the second network node is a second UE in the second cell.

20. The method of claim 19, wherein the optimal reflection coefficient of the second RIS is determined by the second UE according to signal to interference noise ratios (SINRs) or reference signal received powers (RSRPs) calculated for each candidate reflection coefficient of the second RIS.
